(19) United States
(12) Patent Application Publication
(10) Pub. No.: US 2020/0089205 A1
(43) Pub. Date: Mar. 19, 2020

(54) SYSTEM AND METHOD FOR MANAGING AUTOMATION EQUIPMENT

(71) Applicant: ATS AUTOMATION TOOLING SYSTEMS INC., Cambridge (CA)

(72) Inventors: Stanley KLEINIKKINK, Cambridge (CA); Kevin BORONKA, Cambridge (CA); Nicholas WILLISON, Cambridge (CA)

(21) Appl. No.: 16/571,959

(22) Filed: Sep. 16, 2019

Related U.S. Application Data
(60) Provisional application No. 62/731,405, filed on Sep. 14, 2018.

(51) Int. Cl. G05B 23/02

(52) U.S. Cl. CPC G05B 23/0283

(57) ABSTRACT

A system and method for managing automation stations having one or more pieces of automation equipment in an automation environment. The system includes: a plurality of data collection devices configured to collect data related to a plurality of actuations performed by at least one automation station based on data collection criteria; and at least one processing module in communication with the plurality of data collection devices and configured to aggregate and analyze the collected data to detect one or more statistical anomalies, wherein the processing module determines an adjustment to the at least one automation station or the automation environment to address the statistical anomaly and implements the adjustment.

### RELATED APPLICATIONS

This application claims priority from U.S. Provisional App. No. 62/731,405, filed Sep. 14, 2018, which is hereby incorporated herein by reference.

### FIELD

The present disclosure relates generally to a system and method for managing automation equipment. More particularly, the present disclosure relates to a system and method for managing automation stations made up of automation equipment by collecting and analyzing data to detect statistical anomalies that indicate a current issue or a need for maintenance of automation stations in a manufacturing or automation environment.

### BACKGROUND

Modern manufacturing and automation systems and processes are becoming more complex, at least in part because these systems and processes are required to be fast, accurate and repeatable in order to provide appropriate product quality in short time frames. These automation systems and processes also seek to provide high machine efficiency with low downtime for maintenance, trouble-shooting and the like. For existing manufacturing and automation systems and processes, there is also a trend to provide on-going improvement in one or more of these factors in order to keep pace with the changing manufacturing environment.

Some manufacturing and automation systems have sophisticated technologies for identifying defects in products produced, noting and tracking stoppages/slowdowns in equipment being used, or the like. However, it can still be difficult to determine the cause or source of the defect, machine stoppage or the like and provide appropriate instruction in order to remedy the issue/problem that has caused the defect, machine stoppage or the like. It may also be difficult to predict when an issue will likely occur or when maintenance of a machine or part of a machine may be needed or most efficiently performed as a preventative measure.

While some systems and methods for managing automation equipment are known, they tend to be limited, for example, to a particular machine, and may not provide appropriate detail or monitoring with respect to the whole system or evaluating the fault in question.

As such, there is a need for improved systems and methods for managing automation equipment in manufacturing and automation systems.

### SUMMARY

According to one aspect herein, there is provided a system for managing automation stations having one or more pieces of automation equipment in an automation environment, the system including: a plurality of data collection devices configured to collect data related to a plurality of actuations performed by at least one automation station based on data collection criteria; and at least one processing module in communication with the plurality of data collection devices and configured to aggregate and analyze the collected data to detect one or more statistical anomalies, wherein the processing module determines an adjustment to the at least one automation station or the automation environment to address the statistical anomaly and implements the adjustment.

In some cases, the collected data may include a plurality of levels of data granularity.

In some cases, the plurality of levels of data granularity may include: automation environment data, automation station data, moving element data, nest data and carrier data.

In some cases, determination of an adjustment may include a predictive maintenance request based on a combination of the automation environment data, automation station data, moving element data, nest data and carrier data.

In some cases, the determination of a statistical anomaly may include an instance of higher performance or lower performance.

In some cases, the processing module may analyze the collected data by analyzing a data group.

In some cases, the automation station may include a first actuator and a second actuator, and the data group may include first actuator data associated with the first actuator and second actuator data associated with the second actuator.

In some cases, the data collection criteria may include sampling a subset of the plurality of actuations.

In some cases, the data collection criteria may include adapting sampling based on a determined likelihood of a statistical anomaly.

In another aspect there is provided a method of managing automation stations having one or more pieces of automation equipment in an automation environment, the method including: collecting, via a plurality of data collection devices, data related to a plurality of actuations performed by at least one automation station based on a data collection criteria; aggregating, via a processor, the collected data; analyzing, via the processor, the collected data to detect statistical anomalies; determining, via the processor, an adjustment to the at least one automation station or the automation environment to address the statistical anomaly; and implementing, via the processor, the adjustment.

In some cases, the collected data may include a plurality of levels of data granularity.

In some cases, the plurality of levels of data granularity may include: automation environment data, automation station data, moving element data, nest data and carrier data

In some cases, determining an adjustment may include determining a predictive maintenance request based on a combination of the automation environment data, automation station data, moving element data, nest data and carrier data.

In some cases, the detection of a statistical anomaly may include an instance of higher performance or lower performance.

In some cases, the analyzing the collected data may include analyzing a data group.

In some cases, the automation station may include a first actuator and a second actuator, and the data group may include first actuator data associated with the first actuator and second actuator data associated with the second actuator.

In some cases, the data collection criteria may include a scatter sampling.

In some cases, the data collection criteria may be refined based on detection of statistical anomalies.

In some cases, the implementing may include adjusting the automation environment.

In some cases, the implementing may include preventing an actuation related to selected combinations of the pieces of automation equipment.

Other aspects and features of the embodiments of the system and method will become apparent to those ordinarily skilled in the art upon review of the following description of specific embodiments in conjunction with the accompanying figures.

### BRIEF DESCRIPTION OF THE DRAWINGS

Embodiments of the system and method will now be described, by way of example only, with reference to the attached Figures, wherein:

FIG. 1 is a block diagram illustrating an automation environment of a system for managing automation equipment;

FIG. 2 is a block diagram illustrating an embodiment of a system for managing automation stations;

FIG. 3 is a flow chart illustrating an embodiment of a method for managing automation equipment;

FIG. 4 illustrates a screen/user interface showing a high level view of overall OEE for an assembly line or the like;

FIG. 5 illustrates additional detail related to various zones on the assembly line that may be reached by clicking/touching an element on the screen/report shown in FIG. 4;

FIG. 6 illustrates additional detail related to a particular process;

FIG. 7 illustrates a user interface showing trend data for a process, machine or the like;

FIG. 8 illustrates a user interface showing data/information on trends in cycle time;

FIG. 9 illustrates a user interface showing data/information on trends in cycle time;

FIG. 10 illustrates a maintenance schedule that can be prepared by a system or method according to an embodiment herein; and

FIG. 11 is a flow chart illustrating an embodiment of a method for managing automation interactions for automation equipment.

### DETAILED DESCRIPTION

The following description, with reference to the accompanying drawings, is provided to assist in understanding the example embodiments. The following description includes various specific details to assist in that understanding but these are to be regarded as merely examples. Accordingly, those of ordinary skill in the art will recognize that the various embodiments described herein and changes and modifications thereto, including the use of elements of one embodiment with elements of another embodiment, can be made without departing from the scope and spirit of the appended claims and their equivalents. In addition, descriptions of well-known functions and constructions may be omitted for clarity and conciseness.

The terms and words used in the following description and claims are not limited to their bibliographical meanings, but, are meant to be interpreted in context and used to enable a clear and consistent understanding.

Generally, the present document provides for a system and method for managing automation stations and equipment. In one embodiment, the system and method may monitor and collect data associated with various stations and/or equipment and accumulate data over a period of time to determine statistical anomalies regarding the stations, equipment or the automation process. In some cases, the system may predict when a station or piece of equipment will require maintenance or other adjustment in order to promote functionality within a desired range. In some cases, the system and method are intended to determine any grouping of equipment or elements that function at a better or worse level than a predetermined threshold.

It will be understood that automation stations are used on manufacturing or production lines to handle manufacturing operations. An automation station may include a single piece of equipment/machine in a production line, such as a press or the like, but may also include a complex system involving robots, conveyors, manipulators, and the like. Further, the automation station may receive a moving element which may include at least one carrier/pallet per moving element configured to move a part into and/or out of the automation station. In some cases, each carrier may include at least one nest. It will be understood that the moving element itself may directly carry the at least one nest without a carrier so, for the description herein, the terms carrier and nest may be used interchangeably. Each automation station will generally be configured to interact with a part held in the nest as the moving element moves by or stops at each automation station. For example, automation equipment at the automation station may perform a predetermined process on the part in the nest. Generally speaking, automation stations/equipment has been difficult to manage, due to the various interactions of the equipment with parts and the typically large amount of data required to review, understand and predict maintenance and potential issues or failures involving the equipment.

Conventional systems generally have difficulty analyzing data with a level of specificity or granularity that may be required to determine issues or statistical anomalies with respect to the numerous actuations and interactions within a complex automation system in real time or close to real time.

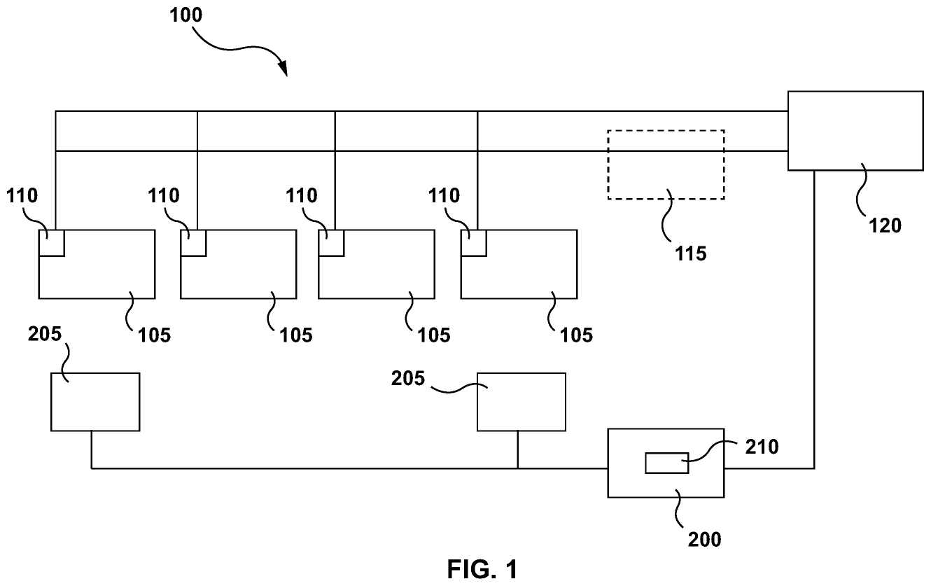

FIG. 1 shows an example environment automation or production line 100 for a system 200 for managing automation equipment according to an embodiment herein. An automation line or production line 100 generally includes at least one automation station, or automation element, 105 (which in the current example includes four automation stations 105). As noted above, the automation stations 105 may be or include, for example, machines, sensors, devices, or equipment, or a combination of machines, devices, or equipment, or the like. Each automation station 105 may include an automation controller 110, such as a programmable logic controller (PLC) 110, which controls the automation station 105. Each PLC 110 is generally in communication with one or more servers or controllers, which may include a production controller 115 and may also or alternatively include a production monitoring server 120. The production controller 115 may provide direct control to and configuration of the PLCs 110 and monitor the overall production line 100. The production monitoring server 120 may monitor and process various operation data received from each PLC 110. Examples of operation data may include, but is not limited to, machine identification, timestamp, full machine state, environmental conditions, or any other data that could be provided in relation to a machine or automation station 105 in the production line. The production monitoring server 120 may analyze the operation data for various purposes.

As noted, each automation station 105 will, at least periodically, interact with at least one product being operated on within the production line, for example, processed, assembled, or the like. The product may be conveyed to each automation station 105, for example, using a moving element (not shown), which may include a carrier, a nest, or the like. In some cases, the product may be located on a nest associated with the moving element. Further, the automation station 105 may grip, rotate, lift, or otherwise alter the position of a product and/or nest and/or moving element once it arrives at the automation station 105. In some cases, the automation station 105 may only perform an operation on some but not all of the parts/nests associated with the moving element.

The production controller 115 and the production monitoring server 120 may include a processor and memory (not shown in FIG. 1) allowing for the processing of various data and operations by each of these elements and monitoring the processing of the automation station 105 or of the production line 100. It will be understood that the production controller 115 and the production monitoring server 120 may be combined or may be housed on a single physical computing device or may be distributed across a number of devices. (For the purposes of this document, the combination of the production controller 115 and the production monitoring server 120 may also be referred to as “production monitoring server 120”.)

A system for managing automation equipment 200 according to an embodiment herein, may include a data acquisition module 210 and one or more data acquisition or collection devices 205. The data acquisition module 210 monitors the operation data received from the PLC 110 (in some cases, via the production monitoring server 120) and data collected by the data collection devices 205 and the system 200 determines automation conditions of the automation station. Automation conditions of the automation station may include, for example, speed, accuracy, efficiency, and the like. In the description herein, the term “automation conditions” will generally refer to conditions associated with the automation process at each automation station. For example each cycle at each automation station may include one to many actuations. Each actuation may be monitored alone or as a series of actions and these actuations may be reviewed/monitored by, for example, sensors or the like, either fed to the PLC 110 or as an element of a data collection device 205, to determine automation conditions for each automation station.

The system 200 may also determine automation conditions from the operation data provided by the production monitoring server 120, which may include, for example, machine stoppages, faulty part detection, out of specification operations or parts, a machine not responding or taking an action within or after a set time period, inappropriate interaction between the automation station and the moving element or part of the moving element, general repair or maintenance of a machine, a combination of events or data, and the like. Generally speaking, the system 200 is intended to determine various negative or abnormal automation conditions in close to real time from the collected data. The system is also configured to aggregate data and determine or review statistical anomalies as an indicator of a potential problem, which may prompt corrective actions. The collected data is intended to be gathered and reviewed on at least a predetermined period. In some cases, artificial intelligence and/or machine learning may be used as well to determine and review the data in close to real-time. As described further below, the collected data is a set of data collected and associated with each automation station and the actuations and interactions within the automation station as determined by the system 200.

The system may further determine a maintenance schedule for the parts of a machine and/or a machine or system based at least in part on the data collected and the number of actuations completed by each part/machine/system. In some cases the time or number of uses of each part, machine or device may be a predetermined threshold and the system may determine when the threshold is met. In other cases, the system may employ machine learning regarding each part, machine or device and the data collected about the automation conditions, and may determine from previous results when the part may need maintenance. In other cases, the determination of the need for maintenance or a maintenance schedule may be a combination of predetermined thresholds and machine learning.

In FIG. 1, two data collection devices 205 are shown. Data collection devices 205 may be any of various devices capable of collecting data, such as feed-back data, that might be useful in diagnosing an issue and providing training with that issue, or associated with the automation station being monitored. In some cases, the data collection devices may be cameras, laser diagnostics, temperatures sensors, pressures sensors, load cells (force sensors), and the like. The data collection devices may be onboard sensors that are already components of the automation station or of a machine and the system may not require or may also have dedicated sensors to determine the data associated with the automation station.

Each data collection device 205 may include a memory (not shown) for storing data captured by the data collection device 205. In some cases, the data collection device 205 may be in communication with the data collection server 210 where additional data may be stored if the memory is not present or is not sufficiently large. Each data collection device 205 may continuously collect data and, if the memory (or data collection server 210) becomes full, data may be transferred to a further data store or other storage device (not shown in FIG. 1) operatively connected to the system. The data collection devices 205 may be in communication with the production monitoring server 120, either directly or via the data collection server 210.

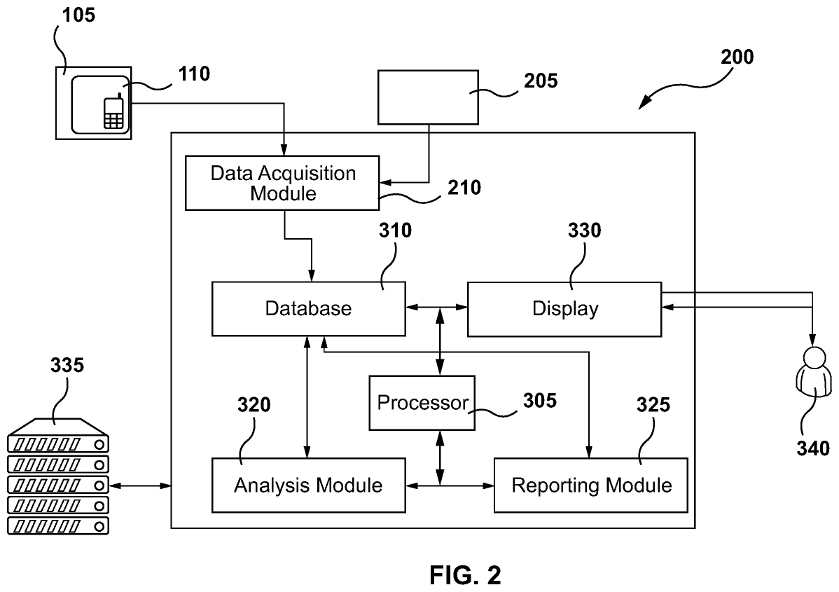

FIG. 2 is a block diagram illustrating an embodiment of the system 200 for managing automation stations and equipment. The system 200 includes the data acquisition module 210, a processor 305, a data storage (such as database 310), an analysis module 320, a reporting module 325 and a display 330. The system 200 may further be operatively connected to a data store 335, which may be physically connected to the system 200 or may be remotely accessible by the system 200. While in FIG. 1, the system 200 is shown as a separate element, the system 200 may alternatively be a part of the production monitoring server 120, the production controller 115 or any combination thereof. The system 200 is intended to interact with an end user 340 and provide various reports and notifications to the end user 340.

The system 200 is intended to receive data associated with the automation system via the data acquisition module 210, which receives data from the one or more PLCs 110 related to the one or more automation stations 105 and/or from the data collection devices 205.

As the data flows into the system 200, the data acquisition module 210 is configured to review the data, including operation data, PLC data and the like. The data acquisition module 210 may also receive general device data and edge data from other data sources. In some cases, the data acquisition module 210 may determine an order of actuations to review per automation station, and all actuations within the automation station will be reviewed in that order. The system may further determine the actuation time, and monitor the timing associated with each automation. This can be beneficial if there are significant amounts of data to review, and real-time review of all data may be impractical. In some cases, the sampling and review may be selected based on system processing capabilities. For example, the sampling order may be predetermined by the system or by an end-user. Data analysis using scatter plots or equations can be used to find potential correlations in the data. From potential correlations sampling can be modified by the system or by an end-user, using methods such as Random sampling, Systematic sampling, Multistage Sampling, Cluster Sampling, or artificial intelligence and machine learning modifications to the sampling, to provide targeted data verifying data correlations. In other cases, the data acquisition module 315 may review specific actuations at a higher frequency or with a higher priority. The system may select specific actuations or data to review based on various factors, for example, the actuation trending off average, previous anomaly with a station or collective group of stations, having a component with a shorter lifecycle, more frequently requiring maintenance than other actuations, or the like.

In other cases, the data review may be based on machine learning and/or Artificial Intelligence (AI). They system may learn, via the accumulation of data, which actuations and/or which automation stations require more frequent review and which may be lower priority and/or lower frequency.

The incoming operation data may be saved into the storage component 310, for example a database, data link, data storage, cloud storage or the like. The operation data may also be communicated to the analysis module 320 and may further be stored in the data store 335. The analysis module 320 is configured to review and aggregate the collected data. In some cases, the data may be aggregated in a manner predetermined by the user. In other cases, the data may be aggregated to track sequences of actuations of a product cycle through the automation system. In still other cases, the data may be aggregated to determine averages, trends and anomalies in the automation station or automation process and may be accomplished by, for examples, least squares analysis, regression analysis, machine learning or the like.

The analysis module 320 may communicate with the reporting module 325 to determine what data and what granularity level of data should be reported to the end-user. In some cases, the analysis module may aggregate the data in various manners to provide the end user 340 viewing and reporting options on the collected data associated with each automation station. In some cases, the analysis module may accumulate the data and allow input from the end-user 340 on display and reporting of the data. The system 300 is intended to provide extensive granularity of data but also provide for amalgamated data to allow an end-user to get a quick overall idea of the status. The levels of granularity could include, for example, each nest, moving element, automation station, group of stations, and the overall automation system. In some cases, the levels of granularity may also include waiting times between any of the nest, moving element, automation station, group of stations, and the overall automation system.

The reporting unit 325 communicates the various reports to the display 330. The end-user 340 may view the various reports on the display 330. The display or the system may provide the end-user with the ability to drill down to view data, aggregated charts and summaries of each automation station and each actuation in the automation station via a user interface (not shown in FIG. 2).

In some cases, the system, for example, the data acquisition module 315 may also provide access for the end user 340 to enter configurable settings for the system 300, for example by setting the types of events/trigger conditions for monitoring, various threshold levels for automation station cycles or actuations, actuations that should be monitored at a higher frequency, and the like. In some cases, the data acquisition module 315 may monitor trends and may determine how far current measurements are from a mean or if the measurements are following a trend. In a specific example, the data acquisition module 315 may consider whether a measurement is further than 3 standard deviations away from a mean, whether there has been a trend of increases and or decreasing measurements, how far the current measurement is from the last measurement, and whether there have been a significant number of measurements over or under the mean in the last few measurements taken. If certain conditions are noted, the data acquisition may determine that the actuations should be monitored at a higher frequency, that an end user should be notified, or that corrective action should be taken.

Data collection devices 205 may, in some cases, include or be associated with cameras, or other input devices in order to monitor the automation equipment. It is intended that data is collected and reported in real time (or close to real time) in order the operator or end user to be given accurate and current data related to the automation system.

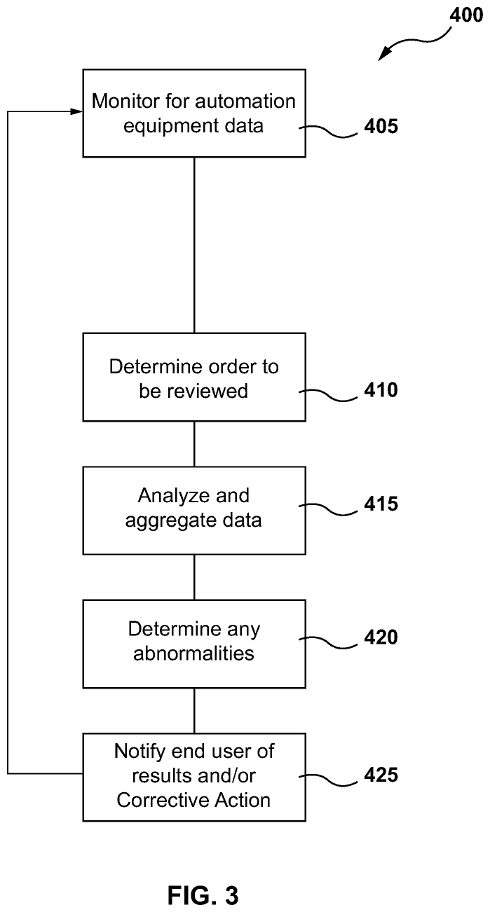

FIG. 3 is a flowchart of an embodiment of a method 400 for managing automation stations and equipment. The system 200 monitors for and receives data from the PLCs/data collection devices at 405. The data is associated with at least one actuation of at least one automation station and may further be associated with a moving element, a carrier, a nest or other equipment that is present during the at least one actuation. The system may continuously monitor and receive data while the automation equipment is in use.

At 410, the system can determine an order or number of readings for each actuation to be reviewed and gathers data with respect to each actuation. As each actuation may be completed from several hundred times per minute to as few as less than a hundred times per hour, the system may select to only review a sampling of each actuation. In some cases, the sampling may be determined on the frequency of the actuation, the parts involved in the actuation, or the like. In some cases, the rate of sampling may be adapted when there is a suspected anomaly or the like. In some cases, each actuation may be reviewed and only data associated with abnormal actuations may be stored. In some cases, all actuations and all data may be stored, either permanently or for a predetermined amount of time. In some cases, the data stored may be aggregated data.

At 415, the system analyzes and aggregates data to determine any anomalies. Due to the volume of data received by the system, the analysis module may be associated with or operatively connected to multiple processors or otherwise provided with additional processing power. In some cases, the system may have a predetermined order for completing the analysis. The order may be determined in a manner to ensure that any larger abnormality would be determined prior to smaller or less concerning abnormalities.

At 420, the system may determine if there are any abnormalities that can be or need to be corrected/adjusted automatically and/or reported to/addressed by an end user or operator. In particular, the system may quickly determine whether there is any data that illustrates the process is out of control, for example, if one or more data readings is beyond control limits, for example more than three standard deviations from the mean; if an excessive number of data readings are on the same side of the mean for the actuation; the data measurements from the actuation appear to have a trend of increasing or decreasing for a predetermined number of measurements; a significant number of data measurements illustrate a trend of alternating increases and decreases; two or three measurements in a row are more than two standard deviations from the mean in the same direction or four or five out of five measurements are more than one standard deviation from the mean in the same direction; or other types of measurement that could indicate the actuation is out of control. If it is determined that there is an out of control pattern, the end user may be immediately contacted and the actuation or automation station may be stopped, flagged for further investigation, adjusted automatically, automatically put on a maintenance schedule, or the like. In some cases, the system may prompt requests for service, additional diagnostics, a formal investigation of root cause analysis or the like.

In some further cases, anomalies may be detected via machine learning, artificial intelligence and/or pattern recognition. In some cases, anomalies may be detected or data may be reviewed in more detail after particular results are reviewed by the data analysis module 320.

If anomalies are detected, at 425, the system may proceed with corrective action/adjustment in order to remedy the anomaly. In some cases, the system may avoid the interaction or actuation that is causing the anomaly or may attempt to control the interaction or actuation. In still other cases, the corrective action may be an interim adjustment or a continuous adjustment to the automation station or automation system to allow for better performance results going forward.

Also at 425, the end user may be notified of the various results and may be able review various charts and graphs related to aggregated data for each automation station and for each device of the automation station. The end user may be given the ability to drill down on various aspects and view results of the analyzed data in different manners. In some cases, the user may receive an email or other form of notification with respect to any anomaly determined by the system. In other cases, the detection of an anomaly may lead to a visual display change associated with the automation station providing a visual cue that an anomaly has been determined. In a specific example, an LED display associated with the automation station or automation system may display that an anomaly has been detected with respect to a specific station.

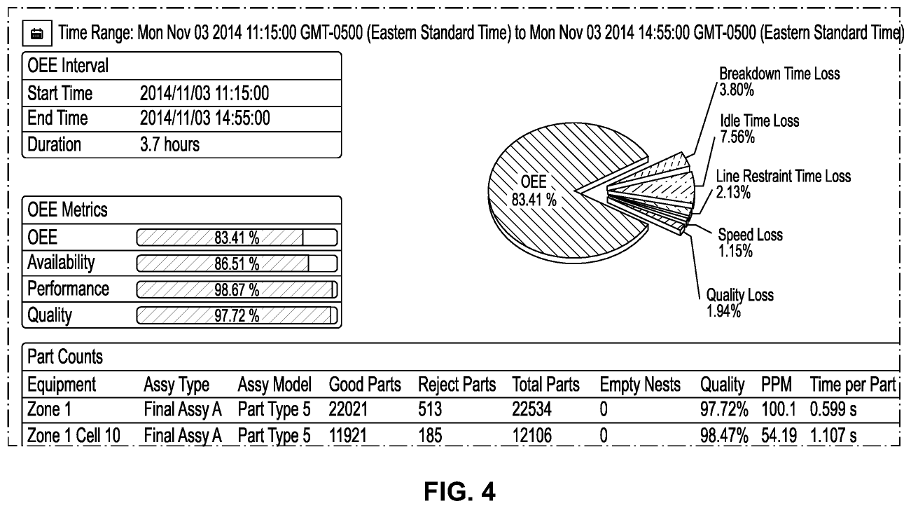

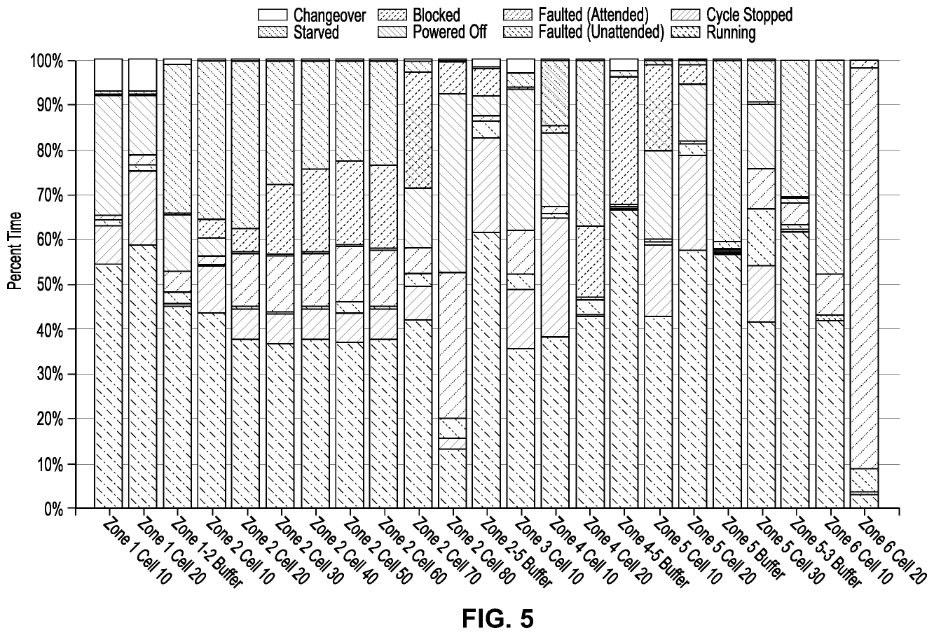

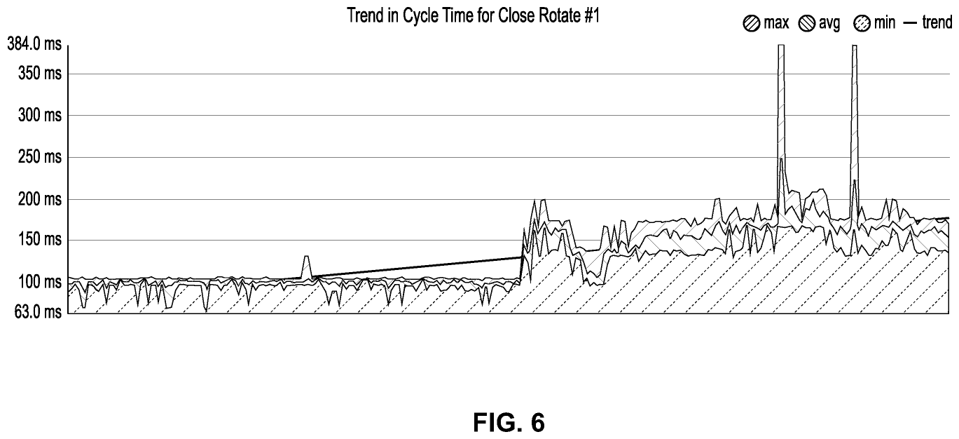

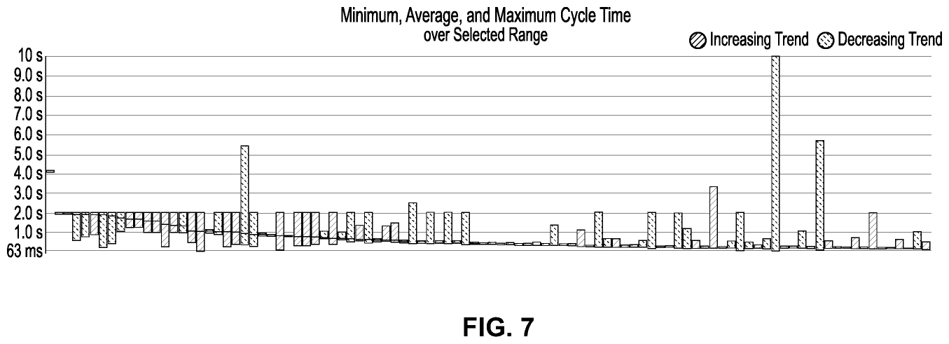

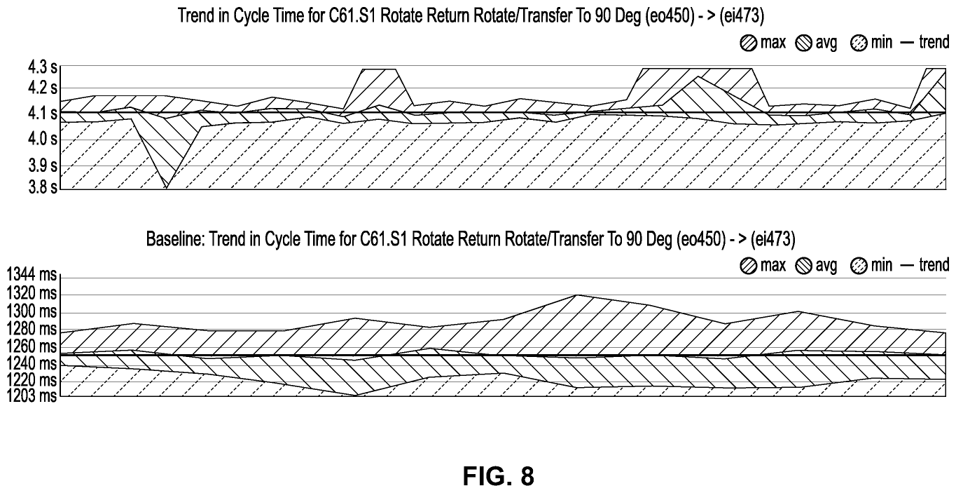

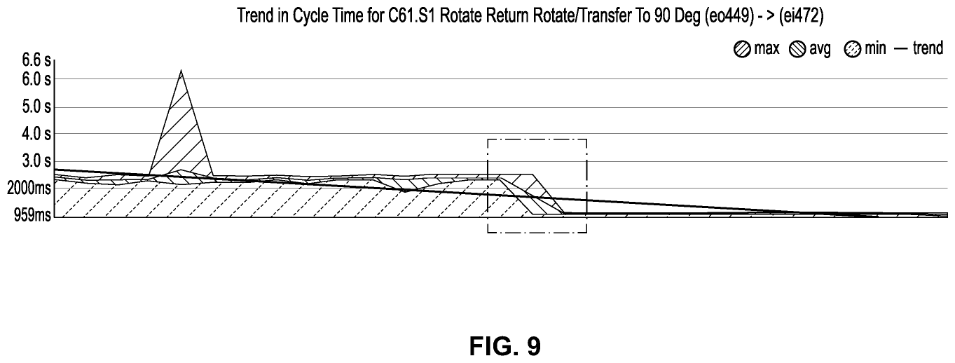

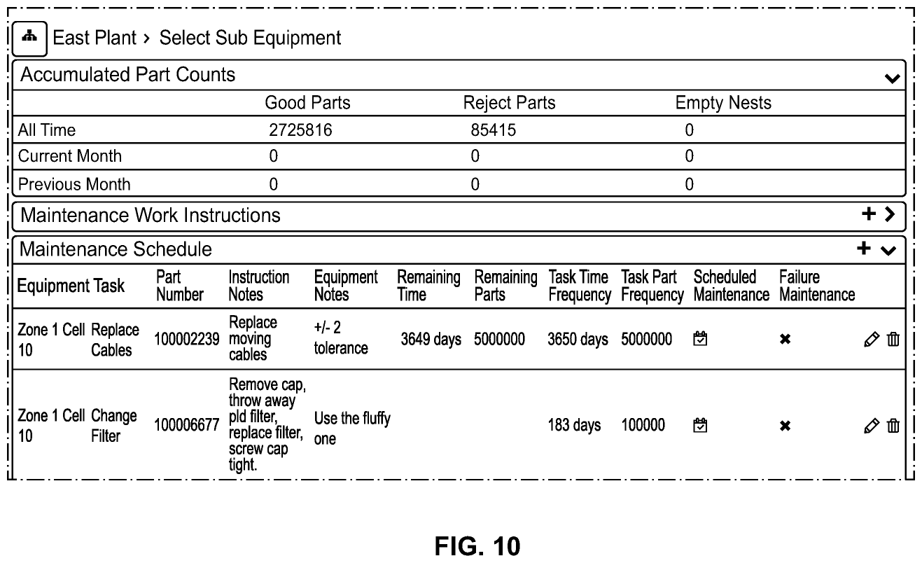

FIGS. 4 to 10 illustrate various reports that may be displayed via a user interface to the end user. The user interface may include input devices/methods (mouse, touch, and other available user interface methods) to allow the end user to select items and drill down to further levels of data. For example, FIG. 4 illustrates a high level view of overall OEE for an assembly line or the like. FIG. 5 shows additional detail related to various zones on the assembly line that may be reached by clicking/touching an element on the screen/report shown in FIG. 4. FIG. 6 illustrates additional detail related to a particular process/actuation. FIG. 7 shows trend data for a process, machine or the like. FIGS. 8 and 9 show data/information on trends in cycle time. FIG. 10 shows a maintenance schedule that can be prepared by the system.

As can be understood from these reports, an end user may be able to view the information in various graph or chart forms. In some cases, the reports are intended to display high level results which can be further reviewed at a more detailed level if required. Having the information accumulated and displayed in a graph or other visual manner is intended to allow the end user to readily spot anomalies or out of control processes without reviewing significant numerical data. In some cases, as shown in FIG. 9, a trend may be highlighted or otherwise brought to an end user's attention. In cases where a trend is highlighted, an end user may click or otherwise access further data in the trend to determine further information regarding the trend. In some cases, an end user will be notified of any trend that may indicate an out of control process as detailed above.

In some cases, the system is further intended to provide more detailed information about each actuation and each device/piece of equipment used within the actuation (see FIG. 6 as an example). The end user may determine various aspects about each piece of equipment/device, including the maintenance time, replacement time, and any further notes that may have been included with respect to each device. In some cases, the end user, or a specific type of end user, for example administrators, may have the ability to edit the data, for example, note when a part is replaced, has had maintenance or has failed. In other cases, the system may determine these aspects from review of each automation station.

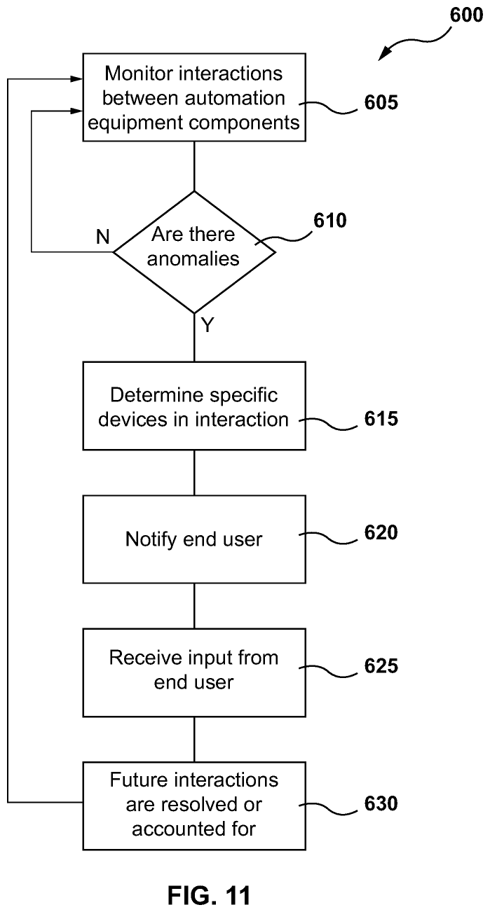

FIG. 11 illustrates a method for managing automation equipment 600 according to an embodiment. In particular, the method 600 relates to interactions between/among automation equipment and/or components. At 605, the system monitors interactions between automation equipment and components. In particular, the system collects data as to which moving elements, carriers, nest or transported parts/articles are interacting with which equipment piece or device in an automation station at each actuation. The interactions may be tracked throughout the automation or manufacturing station to determine the complete set of interactions each component has with each piece of automation equipment. It is intended that this information will be useful in determining any interactions that lead to abnormalities, even when the equipment and components are otherwise performing properly.

In a specific example, the automation system may have 100 moving elements wherein each moving element may include 4 nests and the nests may interact with 6 punches. The number of possible interactions in this specific example would be 100 moving elements*4 nests*6 punches, which results in 2400 possible combinations of interactions. During the production in the automation system, an actuation may require a hole to be punched in the product carried by each nest. Using sensors, inspection or the like, it may be determined that every time nest 3 of moving element 52 interacts with hole punch 2, the product experiences a misalignment. As each product, carried by a nest, may have various activities associated with the product while acted on from the automation system, it will be understood that there may be hundreds, thousands or more interactions which the automation system may have to perform to complete a product. Without reviewing and analyzing the interactions, a specific interaction may go unnoticed and may result in products that do not meet an acceptable quality assurance level.

The system monitors the interactions to determine these anomalies, at 610. If no anomaly is detected, the system will continue to monitor. If anomalies are detected, the system, at 615, will use the statistical analysis and/or machine learning techniques identified herein to determine which interaction is the specific interaction that is causing the issue.

Once the specific interaction is determined, at 620, the system may notify the end user of the interaction. In some cases, the system may display a report illustrating the issue, in other cases, the user may receive an email or text to a predetermined address, or other form of communication notifying the end user of the issue.

At 625, the system may receive input from the end-user in relation to the abnormal interaction. In some cases, the end user may pause the system in order to fix any issues. In some cases, the system may suggest an adjustment that can be made and the end user may approve the adjustment. In order to fix an issue, at 630, the end user or the system may, for example, remove the moving element from production, may replace the nest with a new nest, may make an adjustment (either automatic or instructed/approved by the end user) in the positioning of automation components or parts so that the anomaly is corrected. In other cases, the end user may provide a response that will allow the products to be flagged as having the anomaly determined by the system. While undertaking some activity to resolve, account for or monitor the anomaly, the system will continue monitoring at 605.

In some cases, the system may address the anomaly without user interaction. In particular, the system may ensure that the interaction is not experienced by the manufacturing system, once determined. In some cases, the system may adjust the cycle rates or lengths at an automation station, may reposition a moving element to amend the alignment, or may adjust an automation station to vary the temperature or alignment at the automation station.

For example, with reference to the specific example above, this may be resolved by leaving nest 3 empty on moving element 52, by adjusting positioning of moving element 52 in conjunction with hole punch 2, by controlling the interaction so that moving element is always rotated in such a fashion that hole punch 2 does not interact with nest 3, or any of various other changes that can overcome the anomaly. As such, the anomaly may be resolved without the need for an end user to address the situation.

In another example, the system and method may monitor and receive data related to the temperature of an automation station associated with a linear motor conveyor. In the analysis of the data, the system may determine that the temperature has increased beyond, for example, a predetermined threshold, such as a predetermined safe operating temperature, or the like. In a particular example, the automation station, moving element, and/or other component that may include metal parts may suffer from thermal expansion during operation of a conveyor or during the operation at the automation station. In some cases, on detecting the temperature increase, the system may provide a temperature adjustment to eliminate or reduce any thermal expansion that might be experienced. In some cases, the system may increase spacing to allow further cool air to circulate, in other cases the system may operate a fan, increase air conditioning, increase coolant being run to the automation station, or other action to reduce the temperature experienced by the component. In this example, by monitoring the conditions and adjusting the automation system on determination of a temperature change, it is intended that the system may provide for better continuous performance and may be able to self-heal particular issues.

In the preceding description, for purposes of explanation, numerous details are set forth in order to provide a thorough understanding of the embodiments herein. However, it will be apparent to one skilled in the art that these specific details may not be required. In other instances, well-known structures or circuits may be shown in block diagram form in order not to obscure the overall system or method. For example, specific details are not provided as to whether the embodiments described herein are implemented as a software routine, hardware circuit, firmware, or a combination thereof.

Embodiments can be represented as a software product stored in a machine-readable medium (also referred to as a computer-readable medium, a processor-readable medium, or a computer usable medium having a computer-readable program code embodied therein). The machine-readable medium can be any suitable tangible medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment. Those of ordinary skill in the art will appreciate that other instructions and operations necessary to implement the described embodiments can also be stored on the machine-readable medium. Software running from the machine-readable medium can interface with circuitry to perform the described tasks.

The above-described embodiments are intended to be examples only. Elements of one embodiment may be used with other embodiments and not all elements may be required in each embodiment. Alterations, modifications and variations can be effected to the particular embodiments by those of skill in the art without departing from the scope of the invention, which is defined solely by the claims appended hereto.

What is claimed is:

1. A system for managing automation stations comprising one or more pieces of automation equipment in an automation environment, the system comprising:
a plurality of data collection devices configured to collect data related to a plurality of actuations performed by at least one automation station based on data collection criteria; and
at least one processing module in communication with the plurality of data collection devices and configured to aggregate and analyze the collected data to detect one or more statistical anomalies, wherein the processing module determines an adjustment to the at least one automation station or the automation environment to address the statistical anomaly and implements the adjustment.

2. The system of claim 1, wherein the collected data comprises a plurality of levels of data granularity.

3. The system of claim 2, wherein the plurality of levels of data granularity comprise: automation environment data, automation station data, moving element data, nest data and carrier data.

4. The system of claim 3, wherein the determination of an adjustment comprises a predictive maintenance request based on a combination of the automation environment data, automation station data, moving element data, nest data and carrier data.

5. The method of claim 1, wherein the determination of a statistical anomaly comprises an instance of higher performance or lower performance.

6. The system of claim 1, wherein the processing module analyses the collected data by analyzing a data group.

7. The system of claim 6, wherein the automation station comprises a first actuator and a second actuator, and the data group comprises first actuator data associated with the first actuator and second actuator data associated with the second actuator.

8. The system of claim 1, wherein the data collection criteria comprises sampling a subset of the plurality of actuations.

9. The system of claim 8, wherein the data collection criteria comprises adapting sampling based on a determined likelihood of a statistical anomaly.

10. A method of managing automation stations comprising one or more pieces of automation equipment in an automation environment, the method comprising:
collecting, via a plurality of data collection devices, data related to a plurality of actuations performed by at least one automation station based on a data collection criteria;
aggregating, via a processor, the collected data;
analyzing, via the processor, the collected data to detect statistical anomalies;
determining, via the processor, an adjustment to the at least one automation station or the automation environment to address the statistical anomaly; and
implementing, via the processor, the adjustment.

11. The method of claim 10, wherein the collected data comprises a plurality of levels of data granularity.

12. The method of claim 11, wherein the plurality of levels of data granularity comprise: automation environment data, automation station data, moving element data, nest data and carrier data

13. The method of claim 12, wherein the determining an adjustment comprises determining a predictive maintenance request based on a combination of the automation environment data, automation station data, moving element data, nest data and carrier data.

14. The method of claim 10, wherein the detection of a statistical anomaly comprises an instance of higher performance or lower performance.

15. The method of claim 10, wherein the analyzing the collected data comprises analyzing a data group.

16. The method of claim 15, wherein the automation station comprises a first actuator and a second actuator, and the data group comprises first actuator data associated with the first actuator and second actuator data associated with the second actuator.

17. The method of claim 10, wherein the data collection criteria comprises a scatter sampling.

18. The method of claim 17, wherein the data collection criteria is refined based on detection of statistical anomalies.

19. The method of claim 10, wherein the implementing comprises adjusting the automation environment.

20. The method of claim 10, wherein the implementing comprises preventing an actuation related to selected combinations of the pieces of automation equipment.
